(19) United States
(12) Patent Application Publication
(10) Pub. No.: US 2025/0382199 A1
(43) Pub. Date: Dec. 18, 2025

(54) Sorbents for Nutrient Removal from Water

(71) Applicant: TDA Research, Inc., Golden, CO (US)

(72) Inventors: Steven Dietz, Denver, CO (US); Ambalavanan Jayaraman, Highlands Ranch, CO (US); Matthew Schaefer, Lakewood, CO (US); Jeremy Noce, Lakewood, CO (US); Ewa Jonska-Muteba, Westminster, CO (US); Meredith Haanstad, Thornton, CO (US)

(21) Appl. No.: 19/238,018

(22) Filed: Jun. 13, 2025

Related U.S. Application Data
(60) Provisional application No. 63/659,594, filed on Jun. 13, 2024.

(51) Int. Cl. C02F 1/28; B01J 20/02; B01J 20/06; B01J 20/08; B01J 20/20; B01J 20/28; B01J 20/32; C02F 101/10; C02F 101/16; C02F 101/36

(52) U.S. Cl. CPC C02F 1/288; B01J 20/0281; B01J 20/0288; B01J 20/06; B01J 20/08; B01J 20/20; B01J 20/28064; B01J 20/28066; B01J 20/3204; B01J 20/3236; C02F 1/281; C02F 1/283; C02F 2101/105; C02F 2101/163; C02F 2101/36

(57) ABSTRACT

A sorbent for nutrient removal, preferably nitrate and phosphate removal, or PFAS removal comprising: a porous carbon structure, and a metal doped into the structure, so the metal cannot be removed from the carbon structure by water. The porous carbon structure may comprise an inexpensive carbon source. The metal may be iron, magnesium, zirconium, or aluminum. Preferably, the sorbent comprises 0.1-20% metal compound by weight. Also, a method for nutrient or PFAS removal from water, the steps comprising: providing a sorbent comprising a porous carbon structure, comprising a metal doped into the structure; flowing a polluted water over the sorbent; and, selectively adsorbing a contaminant from the polluted water with the sorbent.

### RELATED APPLICATIONS

The present application claims the benefit of provisional application No. 63/659,594 filed Jun. 13, 2024 (titled Sorbents for Nutrient Removal from Water, by Steven Dietz, Ambalavanan Jayaraman, Matthew Schaefer, and Jeremy Noce), which is incorporated by reference herein.

### STATEMENT OF GOVERNMENT INTEREST

This invention was made in part using U.S. government funding under contract #2R44ES032735-02 awarded by the National Institutes of Health (NIH), National Institute of Environmental Health Sciences. The government has certain rights in this invention.

### BACKGROUND

Nutrient pollution is one of the United States' most widespread, costly, and challenging environmental problems, and is caused by excess nitrogen and phosphorus in the air and water.

Nitrogen and phosphorus are nutrients that are natural parts of aquatic ecosystems. Nitrogen is also the most abundant element in the air we breathe. Nitrogen and phosphorus support the growth of algae and aquatic plants, which provide food and habitat for fish, shellfish and smaller organisms that live in water.

When too much nitrogen and phosphorus enter the environment-usually from a wide range of human activities—the air and water can become polluted. Nutrient pollution has impacted many streams, rivers, lakes, bays, and coastal waters for the past several decades, resulting in serious environmental and human health issues, and impacting the economy.

Too much nitrogen and phosphorus in the water causes algae to grow faster than ecosystems can handle. Significant increases in algae harm water quality, food resources and habitats, and decrease the oxygen that fish and other aquatic life need to survive. Large growths of algae are called algal blooms and they can severely reduce or eliminate oxygen in the water, leading to illnesses in fish and the death of large numbers of fish. Some algal blooms are harmful to humans because they produce elevated toxins and bacterial growth that can make people sick if they come into contact with polluted water, consume tainted fish or shellfish, or drink contaminated water.

Nitrate and phosphate contamination in surface and ground water has become an increasingly important problem all over the world. Although nitrate is found in moderate concentrations in most natural waters, higher levels in ground water mainly results from human and animal waste and excessive use of chemical fertilizers. Other common sources of nitrate and phosphate are uncontrolled land discharges of municipal and industrial waters, overflowing septic tanks, processed food, dairy and meat products, and the decomposition of decaying organic matter buried in the ground. Nitrates and phosphates are extremely soluble in water and can move easily though the soil and into the drinking water supply. United States Geological Survey studies indicate that about 20% of the wells in agricultural areas of the United States exceed the MCL set by the EPA.

In humans, excessive nitrate concentrations in drinking water causes two adverse health effects: induction of “blue-baby syndrome” (methanoglobinemia), especially in infants, and the potential formation of carcinogenic nitrosamines. Nitrate has been shown to dramatically increase the rate of thyroid cancer for women and to birth defects in offspring even at only at half the maximum contaminate level (MCL) set by the EPA of 10 mg/L as nitrate-nitrogen.

Ion exchange, reverse osmosis and distillation are effective in removing nitrate and phosphate, but these technologies are expensive. It would be cheaper and easier to use activated carbons to remove nitrate and phosphate from water because granular activated carbon (GAC) is very inexpensive and is already used to remove organic contaminants. Unfortunately, conventional GACs do not effectively remove nitrates, phosphates, and other highly water-soluble ions. There is a need for improvements in carbon sorbents to address the growing issues of nitrate and phosphate pollution in an economically feasible manner.

Additionally, per- and polyfluoroalkyl substances (PFAS), also commonly known as perfluorinated compounds, are a large family of man-made, globally distributed chemicals that have been used for decades. Perfluorooctanoic acid (PFOA) and perfluorooctane sulfonate (PFOS) are the most common PFAS, but thousands of other derivatives exist. PFAS are emerging environmental pollutants in groundwater, and they are attracting significant attention due to their global distribution, persistence, toxicity and tendency to bio-accumulate. EPA data estimates that drinking water for more than 110 million Americans may be contaminated with PFAS. Once released into the environment, they are not easily broken down by air, water, or sunlight. Thus, people can be exposed to PFAS that were manufactured years or decades in the past. PFAS can travel long distances in the air and water, exposing people to PFAS manufactured or emitted from facilities many miles away. Human exposure can also occur through contact with products containing PFAS. In 2016, EPA established a lifetime health advisory (LHA) level of 70 parts per trillion (ppt) for individual or combined concentrations of PFAS in drinking water and many states are establishing even lower levels. Recently, the EPA announced revised LHAs that are much lower (including 4 ppt for PFOA and PFOS). Epidemiological studies have shown that the occurrence of PFAS in humans is linked to a high incidence of thyroid disease, high cholesterol, ulcerative colitis, kidney cancer, testicular cancer, and pregnancy-induced hypertension. Because current water treatment technologies that can meet the EPA targets are not cost effective, especially for in home use, there is a need for methods to cleanup drinking water that are efficient, cost effective, and can meet the EPA guidelines.

### SUMMARY OF THE INVENTION

The present disclosure provides carbon sorbents that address the problems in the prior art. We provide activated carbons with metal compounds incorporated into the carbon structure and cannot be removed by water. Metal compounds are substances formed when a metal atom bonds with another element or group of elements. In addition, we provide activated carbons doped with metal cations (i.e., iron, zirconium, aluminum, iron, zinc, mixed metals) that can also remove nitrate, phosphate, and PFAS from water. These metal cations can have multiple oxidation states and include all metals of the periodic table including transition, lanthanide, actinide, alkaline earth metals and metalloids. These metal cations can be used singly or in combination. These metal cations are combined with anion(s) (i.e., halides, oxides, sulfates and hydroxides). Other possible anions include phosphate, carbonate, bicarbonate, acetylacetonate and nitrate and the like.

The activated carbons described herein are typically prepared through a two-step process: carbonization and activation. Carbonization involves heating a carbonaceous material (like biomass or coal) in the absence of oxygen to produce biochar. Activation then enhances the microporosity and surface area of the biochar, making it a more effective adsorbent. This can be achieved through physical activation (using steam or carbon dioxide at high temperatures) or chemical activation (using chemicals like phosphoric acid or potassium hydroxide).

This disclosure provides a sorbent for nutrient removal from water, comprising: a porous carbon structure; and, at least one metal cation incorporated into the porous carbon structure; wherein, the metal cation cannot be removed from the porous carbon structure by water; and, wherein, the sorbent selectively removes at least one nutrient from water. The sorbent may selectively remove nitrate or phosphate from water, or both. The porous carbon structure maybe derived from sugar, cornstarch, coal or wood, as well as other similar inexpensive carbon source.

In an embodiment, the metal compound may be selected from the group consisting: iron, magnesium, zirconium, zinc and aluminum. Preferably, the metal is iron or aluminum. In a preferred embodiment, the sorbent comprises 0.1-20% metal compound by weight, or 3-10% metal compound by weight, or most preferably 4.5-5.5% metal compound by weight.

The disclosure also provides a method for contaminant removal from water, the steps comprising: providing a sorbent comprising a porous carbon structure, a metal doped into the porous carbon structure, wherein the metal cannot be removed from the porous carbon structure with water; flowing a polluted water over the sorbent; and, selectively adsorbing a contaminant from the polluted water with the sorbent. The contaminant may be nitrate (nitrogen), or phosphate (phosphorus), or PFAS, or any combination of two of the three, all three, or additional contaminants. The porous carbon structure may be derived from sugar, cornstarch, coconut shells, peet, wood, coal or another similar inexpensive carbon source.

The metal may be selected from the group consisting: iron, magnesium, zirconium, zinc and aluminum. Preferably, the metal is iron or aluminum. In an embodiment, the method comprises doping the sorbent with the metal, wherein doping the sorbent with the metal ion comprises soaking the sorbent in a metal ion solution, the evaporating any water from the sorbent.

In an embodiment, the polluted water is 40 ml of polluted water, and selectively adsorbing a contaminant from the polluted water with the sorbent comprises reducing 10 ppm inorganic nitrogen by at least 45%, reducing 50 ppm total nitrogen by at least 20%, and reducing 30 ppm phosphorus by at least 35%. Preferably, the polluted water is 40 ml of polluted water, and selectively adsorbing a contaminant from the polluted water with the sorbent comprises reducing 10 ppm inorganic nitrogen by at least 80%, reducing 50 ppm total nitrogen by at least 20%, and reducing 30 ppm phosphorus by at least 40%.

The present disclosure also provides a sorbent for PFAS removal from water, comprising: a porous carbon structure; a metal doped into the porous carbon structure; wherein, the metal cannot be removed from the porous carbon structure by water; and, wherein, the sorbent selectively removes PFAS from water. The metal may be selected from the group consisting: iron, magnesium, zirconium, zinc and aluminum. The sorbent preferably comprises 0.1-20% metal compound by weight.

The present disclosure provides a sorbent comprising: a) a carbon content of at least 80 weight percent, a metal ion content of at least 1 weight percent, a chlorine content of at least 0.5 weight percent, and a BET surface area of at least 100 m²/g, or at least 800 m²/g, or at least 936 m²/g.

The present disclosure provides a method for removing nutrients or contaminants including nitrogen, nitrates, phosphorus, phosphates, PFAS, and the like from water using an activated carbon sorbent as described in any of the embodiments in the specification, flowing a contaminated or polluted water over the activated carbon sorbent, and selectively removing the target nutrients or contaminants. The method may use any of the embodiments of metal doped carbon sorbents, with some or all of the additional preferred embodiments or features described herein. Examples provided herein are not intended to limit the scope of the present invention, but rather show certain embodiments that succeed in overcoming the limitations of the prior art.

The metal ions or mixture of metal ions in the sorbent may derive from a metal compound or mixture of metal compounds. The metal compound or the mixture of metal compounds comprises ferric chloride, ferrous chloride, ferrous sulfate, ferric sulfate, iron oxide, iron hydroxide, aluminum chloride, aluminum oxide, aluminum hydroxide, zirconium chloride, zirconium oxide, zirconium hydroxide, zinc oxide, zinc hydroxide, magnesium oxide, magnesium hydroxide, among other similar metal compounds.

### DETAILED DESCRIPTION OF THE INVENTION

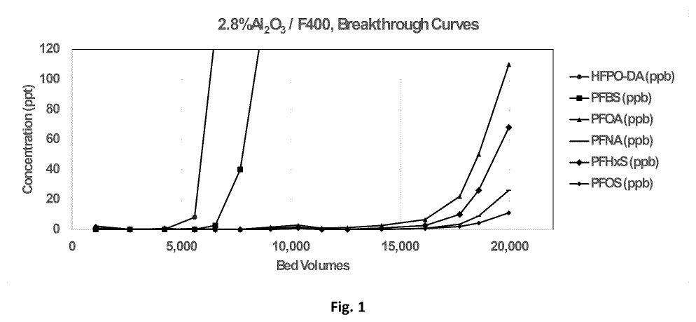

FIG. 1: Breakthrough curves for PFAS compounds.

### DETAILED DESCRIPTION OF THE INVENTION

In the detailed description and throughout the claims, all terms are given their technical meaning unless defined otherwise.

Although the present disclosure has been described in considerable detail with reference to certain preferred versions thereof, other versions are possible. Therefore, the spirit and scope of the appended claims should not be limited to the description of the preferred versions contained herein, except where required by 35 U.S.C. § 112, i 6 or 35 U.S.C. § 112(f).

All the features in this specification (including any accompanying claims, abstract, and drawings) may be replaced by alternative features serving the same, equivalent or similar purpose, unless expressly stated otherwise. Thus, unless expressly stated otherwise, each feature disclosed in one example only of a generic series of equivalent of similar features. Any element in a claim that does not explicitly state “means for” performing a specified function, or “step for” performing a specific function, is not to be interpreted as a “means” or “step” clause as specified in 35 U.S.C. § 112, i 6 or 35 U.S.C. § 112(f). Any element in a claim that does explicitly state “means for” performing a specified function, or “step for” performing a specific function, is to be interpreted as a “means” or “step” clause as specified in 35 U.S.C. § 112, i 6 or 35 U.S.C. § 112(f).

The present disclosure provides inexpensive alternatives to current water decontamination methods (ion exchange, reverse osmosis, and distillation). We provide activated carbon sorbents doped with metal (i.e., iron, aluminum, zirconium) that overcome the deficiencies in the prior art (inexpensive, efficient, comply with EPA standards) and removes nitrates and phosphates from water. Activated carbon, a versatile adsorbent, is derived from various carbonaceous precursors through processes like carbonization and activation. Common precursors include lignocellulosic biomass, agricultural waste, and other carbon-rich materials. These precursors can be obtained from various sources, including sugar, cornstarch, peet, coconut shell, wood and coal.

To further improve the removal of nitrates and phosphates, the activated carbons may be doped with metals such as iron, magnesium, aluminum, zirconium, zinc and the like. The metal doped samples may be prepared in the form of metal halides, oxides, sulfates, and hydroxides on highly porous carbons (surface area >100 m²/g, preferably >800 m²/g, optionally >935 m²/g or >1000 m²/g). Examples are provided herein of carbons impregnated with iron (II), iron (III), aluminum, zirconium containing compounds, and mixtures of metals. The sample formulations for examples in this disclosure are provided in Table 1. The BET surface areas (SA) and pore volumes for the sample formulations are shown in Table 2 (TPV=total pore volume MPV=micropore volume). The carbon sorbents of the present disclosure efficiently remove nitrate, phosphate, PFAS, and other anionic contaminants from water via adsorption by Lewis acid-base functional groups incorporated into the porous carbon structure.

TABLE 1
Sorbent formulations.

| | Lot | Carbon | Metal |
|---|---|---|---|
| Sample# | # | Source | Additive |
| 1 | Ref | Calgon OVC | none |
| 2 | 1605-89C | Calgon OVC | 3.4% Al₂O₃ |
| 3 | 90624 | Calgon OVC | 3.5% FeCl₃ |
| 4 | Ref | Calgon F400 | none |
| 5 | 1605-50D-1 | Calgon F400 | 1% Al₂O₃ |
| 6 | 1605-83B | Calgon F400 | 5% Al₂O₃ |
| 7 | 1605-50A-1 | Calgon F400 | 2% ZrO₂ |
| 8 | 1605-84 | Calgon F400 | 3.5% ZrO₂ |
| 9 | 1545-25D | Calgon F400 | 2.3% FeCl₃ |
| 10 | 1545-26B | Norit Row | 5% FeSO₄ |
| 11 | 1545-27B | Norit Row | 5% FeCl₂ |
| 12 | 1545-27D | Norit Row | 5% Fe₂(SO₄)₃ |
| 13 | 1605-50C-1 | Norit Row | 3.5% Al₂O₃ |
| 14 | 061924 | Norit Row | 3.3% FeCl₂ |
| 15 | 6101-12B | Calgon F400 | 9.6% MgAl(OH)ₓ |
| 16 | 6101-13B | Calgon F400 | 10% ZnAl(OH)ₓ |

TABLE 2
Surface areas and pore volumes of sorbents.

| | | BET | | t-plot |
|---|---|---|---|---|
| | Lot | SA | TPV | MPV |
| Sample | # | (m²/g) | (cc/g) | (cc/g) |
| 1 | Ref | 935 | 0.51 | 0.41 |
| 2 | 1605-89C | 1019 | 0.51 | 0.43 |
| 3 | 90624 | 858 | 0.47 | 0.38 |
| 4 | Ref | 873 | 0.59 | 0.31 |
| 6 | 1605-83B | 936 | 0.57 | 0.31 |
| 8 | 1605-84 | 1012 | 0.60 | 0.33 |
| 9 | 1545-25D | 817 | 0.55 | 0.30 |
| 10 | 1545-26B | 1446 | 0.81 | 0.46 |
| 11 | 1545-27B | 1279 | 0.72 | 0.39 |
| 12 | 1545-27D | 1231 | 0.69 | 0.41 |
| 13 | 1605-50C-1 | 1138 | 0.64 | 0.40 |
| 14 | 061924 | 1318 | 0.74 | 0.44 |
| 15 | 6101-12B | 853 | 0.55 | 0.30 |
| 16 | 6101-13B | 852 | 0.59 | 0.28 |

The samples were tested for nitrate and phosphate removal, and results in Table 3 show that the metal-doped carbon sorbent presented herein consistently provide superior performance over commercial, non-doped sorbents. In each case, a carbon sample (1.0 g) was contacted with a mixture of 50 ppm of nitrate and 30 ppm of phosphate in 40 ml of tap water for 24 hours. Adding metal compounds for iron, aluminum, zirconium, and mixed metals to porous carbon structures resulted in high nitrate and phosphate removal from water. This demonstrates that modifying the surface of the carbons with Lewis acid-base functional groups efficiently removes anionic contaminants such as nitrate and phosphate from water through electrostatic interactions, hydrophobic interactions, and ion exchange. Other metals or transition metals may be doped into the porous carbon, and other carbon structures may be used. The composition may be effective for removing phosphate and nitrate selectively over other waterborne contaminants that are likely to be in stormwater, which would compete or interfere with nitrate or phosphate adsorption. The composition may be effective at removing nitrates, phosphates, PFAS, and other anionic contaminants.

TABLE 3
Sorbents tested for nitrate and phosphate removal.

| Sample | % Nitrate Removal | % Phosphate Removal |
|---|---|---|
| 1 | 72 | 0 |
| 2 | 100 | 81 |
| 3 | 89 | 88 |
| 4 | 81 | 0 |
| 5 | 88 | 78 |
| 6 | 95 | 96 |
| 7 | 79 | 79 |
| 8 | 68 | 96 |
| 9 | 100 | 84 |
| 10 | 90 | 69 |
| 11 | 82 | 66 |
| 12 | 90 | 96 |
| 13 | 84 | 96 |
| 14 | 100 | 79 |
| 15 | 72 | 84 |
| 16 | 88 | 92 |

The present carbon sorbents are also effective in removing PFAS from water. Batch screening tests at realistic concentrations found at contaminated sites were done using a total of 12 ppb of PFAS in tap water, with a liquid to sorbent ratio of 1000:1 and stirred 4 hours at room temperature. Table 4 shows results from batch tests for PFAS removal from drinking water, split into equal amounts of perfluorooctanoic acid (PFOA), perfluorooctanesulfonic acid (PFOS), perfluorononanoic acid (PFNA), hexafluoropropylene oxide dimer acid (HFPO-DA, commonly known as GenX), perfluorohexane sulfonic acid (PFHxS), and perfluorobutane sulfonic acid (PFBS). The present metal doped carbons enhance the PFAS removal efficiency of commercial Calgon carbon (Filtrasorb® series F400) (Sample 1) through electrostatic, ion exchange and Lewis acid-base interactions between the carboxylic and sulfonic acid functional groups on the PFAS molecules and the metal additive. Filtrasorb® 400 is a granular activated carbon for the removal of dissolved organic compounds from water and wastewater as well as industrial and food processing streams—the carbons are produced by stream activation of selected grades of bituminous coal that have first been pulverized then agglomerated. These results show that the present metal functionalized carbons are superior to currently used filter media for PFAS removal.

TABLE 4
Batch tests for PFAS removal from drinking water.

| | Metal | % PFOA | % PFNA | % PFBS | % PFHxS | % HFPO-DA | % PFOS |
|---|---|---|---|---|---|---|---|
| Sample | Additive | Removal | Removal | Removal | Removal | Removal | Removal |
| 1 | None | 83 | 76 | 86 | 82 | 79 | 78 |
| 6 | 5% Al₂O₃ | 95 | 96 | 96 | 96 | 92 | 99 |
| 7 | 2% ZrO₂ | 94 | 94 | 95 | 96 | 89 | 95 |
| 9 | 5% FeCl₃ | 86 | 82 | 84 | 90 | 86 | 86 |

This disclosure also details the doping of carbons with metal solutions (i.e., FeCl₃, AlCl₃). The resulting material can be used for stormwater remediation, and specifically phosphate and nitrate adsorption. The present carbon-based sorbents are selective for nitrate, phosphate, and/or PFAS removal from water. The metal compound loading on carbon is preferably 0.1-20 wt. %, where the metal may be iron, zirconium, magnesium, zinc or aluminum.

The typical procedure for iron-doped carbons is as follows: The ferric chloride (FeCl₃) solution is a 2.5% by weight solution. The mass ratio of solution to carbon is 2:1. The carbon is soaked in glass (or plastic) trays, and the trays are heated to 100-150° C. in a convection oven to evaporate the water. A nominal batch includes: 1400 g DI H₂O, 35 g FeCl₃, and 700 g carbon. After drying, excess FeCl₃ is removed from the carbon by washing with tap water until the filtrate is colorless. The product is then dried at 100-150° C. in a convection oven.

The typical procedure for metal oxide (i.e., alumina, zirconia, mixed) is as follows: The activated carbon is impregnated with an aqueous solution of 5% AlCl₃, then dried at 100° C. for 6 hours in the air. In the next step AlCl₃/AC was treated with an excess of 1N NaOH or KOH to form nanoparticles of aluminum hydroxide as a precipitate on the AC surface and pores, followed by the was with DI water until final pH was neutral. The sorbent was then dried at 100° C. for 6 hours.

Characterization of the carbons was done via X-Ray Photoelectron Spectroscopy (XPS). To determine the elemental composition on the surface of the carbons, they were analyzed by XPS for carbon, nitrogen, oxygen, chlorine, iron, and aluminum, results are shown in Table 5. As expected, the unmodified carbons (samples 1 and 4) showed no iron or aluminum. The metal doped carbons showed the respective metals ranging from 0.2 to 24.1 atom %. Higher metal content is correlated with lower measured carbon content and may be due to metal residing on the outer surface of the carbon rather than in the porous inner part. Preferably, the metal is well dispersed throughout the pores like in sample 9, where the measured iron content is lower because XPS is only capable of detecting elements on the surface of the sample. This was confirmed by comparing the total amount of iron in the sample by elemental analysis (Table 8) with XPS and the results were comparable, 0.804 wt. % for elemental analysis vs. 0.9 wt % for XPS (after converting 0.2 atom % to weight %).

TABLE 5
Relative elemental composition of sample surfaces as determined by XPS.

| | C | N | O | Cl | Fe | Al |
|---|---|---|---|---|---|---|
| Sample | (Atom %) | (Atom %) | (Atom %) | (Atom %) | (Atom %) | (Atom %) |
| 1 | 88.8 | — | 8.0 | 0.2 | — | — |
| 2 | 76.2 | 0.4 | 17.6 | 1.5 | — | 1.2 |
| 3 | 24.0 | 0.6 | 44.9 | 4.7 | 24.1 | — |
| 4 | 90.7 | — | 7.9 | 0.2 | — | — |
| 6 | 81.6 | 0.3 | 13.4 | 0.8 | — | 3.4 |
| 9 | 87.1 | 0.5 | 10.4 | 0.2 | 0.2 | — |

The most probable peak assignments for the C species are listed in Table 6. The samples have a peak present that is labeled π→π*. This represents the presence of graphite like C as this transition only occurs when there is sufficient π-bond conjugation to allow for the π and π* orbitals to form in a large area. This peak was not observed for sample 3, which suggests that other elements present on the surface may have disrupted any π-bound conjugation.

TABLE 6
Relative compositions and most probable peak assignments for carbon
species on sample surfaces as determined by XPS, C 1 s region.

| Carbon | C—C, C—H, | C—O, C—N | C═O, N═C | O—C═O, N—C═O | π→π* |
|---|---|---|---|---|---|
| Sample | (Atom %) | (Atom %) | (Atom %) | (Atom %) | (Atom %) |
| 2 | 66.3 | 12.5 | 6.7 | 3.6 | 10.9 |
| 3 | 54.9 | 28.1 | 10.3 | 6.7 | — |
| 6 | 65.9 | 11.2 | 6.5 | 2.4 | 14.0 |
| 9 | 64.4 | 12.4 | 7.5 | 2.7 | 13.0 |

The most probable peak assignments for the O species are listed in Table 7. All samples show a mixture of carbon to oxygen single and double bonds. Samples 2 and 6 show single bonding between the aluminum and oxygen atoms. Sample 3 shows single bonds between the oxygen and iron atoms as well as single bonding between oxygen and chlorine. The iron and chlorine content for sample 9 were too low to detect oxygen bonding.

TABLE 7
Relative compositions and most probable peak assignments for oxygen
species on sample surfaces as determined by XPS, O 1 s region.

| Carbon | O═C | O—C | | | |
|---|---|---|---|---|---|
| Sample | (Atom %) | (Atom %) | O—Fe | O—Cl | O—Al |
| 2 | 37.5 | 44.3 | — | — | 18.2 |
| 3 | 42.6 | 18.0 | 36.0 | 3.5 | — |
| 6 | 26.4 | 64.3 | — | — | 9.3 |
| 9 | 12.8 | 43.6 | — | — | — |

The elemental composition of selected sorbents were determined by elemental microanalysis and Inductively coupled plasma-optical emission spectroscopy (ICP-OES) and compared to the base carbons (Samples 1 and 4) (Table 8). The carbon content is greater than 80% and metal content, Al or Fe depending on the sample is greater than that found for the base materials.

TABLE 8
Elemental analysis of sorbents.

| | C | H | N | Cl | O | Fe | Al | Ash | S |
|---|---|---|---|---|---|---|---|---|---|
| Sample | (wt. %) | (wt. %) | (wt. %) | (wt. %) | (wt. %) | (wt. %) | (wt. %) | (wt. %) | (wt. %) |
| 1 | 92.6 | 0.45 | 0.18 | 0.458 | 4.76 | 0.006 | 0.005 | 1.88 | 0.129 |
| 2 | 89.6 | 0.43 | 0.15 | 1.17 | 5.65 | 0.073 | 1.34 | 4.17 | 0.004 |
| 3 | 82.9 | 0.39 | 0.18 | 1.26 | 8.07 | 1.31 | 0.825 | 8.32 | 0.137 |
| 4 | 86.8 | 0.36 | 0.44 | 0.134 | 3.65 | 0.183 | 1.08 | 8.04 | 0.711 |
| 6 | 82.7 | 0.50 | 0.15 | 1.17 | 5.65 | 0.162 | 2.31 | 10.7 | 0.655 |
| 9 | 86.3 | 0.33 | 0.51 | 0.987 | 3.71 | 0.804 | 1.10 | 8.47 | 0.684 |

### Example: PFAS Removal Testing

Embodiments of the present sorbents were tested in a fixed bed flow system under realistic flow rates and PFAS concentrations. For example, a 2.8% Al₂O₃/Calgon F400 sorbent was heated at 100° C. overnight to drive off adsorbed gases and water and stored in a desiccator. The sorbent was packed into a stainless steel HPLC column. The sorbent was sieved in the size range of 100-325 mesh (44-149 μm) and a 1 mL volume was measured out in a small, graduated cylinder and weighed (0.4432 g). The sorbent powder was packed into a stainless steel HPLC column, 0.46 cm ID, ×10 cm long. The dead space in the column was packed with glass beads (0.5 mm diameter), and glass wool at both ends. The packed bed volume was measured (0.789 mL).

Six PFAS compounds (PFOS, PFOA, PFNA, PFBS, PFHxS, HFPO-DA, 2 ppb for each compound) were tested. A HPLC pump was used to pump the feed solution through the column. Deionized water was first flushed through the column in an up-flow configuration to drive out air bubbles and thoroughly wet the sorbent for 16 hours. The adsorption tests were performed in a down-flow configuration.

The total test ran for 20,000 bed volumes and the average flow rate for the tests was 0.79 mL/min. Sample solutions were collected and shipped to Eurofins for analysis via LC/MS/MS using EPA Method 537 (modified). The breakthrough curve is shown as a function of bed volumes of PFAS solution treated (FIG. 1). Initially, all the PFAS compounds were removed to nondetectable levels (well below EPA MCLs). HFPA-DA broke through first at about 6,000 bed volume, followed by the PFBS at 7,000 bed volumes (lower molecular weight PFAS compounds are the most difficult to remove). The higher molecular weight compounds showed breakthrough times in the range of 14,000-17,000 bed volumes, showing the success of the present sorbents.

What is claimed is:

1. A sorbent for nutrient removal from water, comprising:
a) a porous activated carbon structure having a surface area greater than 100 m²/g; and,
b) a metal ion or a mixture of metal ions incorporated into the porous carbon structure;
wherein, the metal ion or the mixture of metal ions cannot be removed from the porous carbon structure by water;
wherein, the sorbent comprises 0.2-24 atom % metal as measured by XPS,
wherein, the sorbent selectively removes at least one nutrient from water.

2. The sorbent as in claim 1, wherein the at least one nutrient is selected from the group consisting: nitrate and phosphate.

3. The sorbent as in claim 1, wherein the porous activated carbon structure may be derived from sugar, cornstarch, coconut shells, coal or wood, as well as other similar inexpensive carbon sources.

4. The sorbent as in claim 1, wherein the metal ion or the mixture of metal ions comprises at least one metal from the group consisting: iron, zinc, magnesium, zirconium, and aluminum.

5. The sorbent as in claim 4, wherein the metal ion or the mixture of metal ions comprises iron, zirconium, or aluminum, or zinc.

6. The sorbent as in claim 4, wherein the metal ion or the mixture of metal ions derive from a metal compound or a mixture of metal compounds, and wherein the sorbent comprises 0.1-20% metal compound or mixture of metal compounds by weight.

7. The sorbent as in claim 6, wherein the sorbent comprises 3-10% metal compound or mixture of metal compounds by weight.

8. The sorbent as in claim 7, wherein the sorbent comprises 4.5-5.5% metal compound or mixture of metal compounds by weight.

9. The sorbent as in claim 6, wherein the metal compound or the mixture of metal compounds is selected from the following: ferric chloride, ferrous chloride, ferrous sulfate, ferric sulfate, iron oxide, iron hydroxide, aluminum chloride, aluminum oxide, aluminum hydroxide, zirconium chloride, zirconium oxide, zirconium hydroxide, zinc oxide, zinc hydroxide, magnesium oxide, magnesium hydroxide.

10. A method for contaminant removal from water, the steps comprising:
a) providing a sorbent comprising a porous carbon structure with a metal compound or a mixture of metal compounds incorporated into the porous carbon structure, wherein the metal or the mixture of metals cannot be removed from the porous carbon structure with water, and wherein the porous carbon structure has a surface area greater than 100 m²/g;
b) flowing a polluted water over the sorbent; and,
c) selectively adsorbing a contaminant from the polluted water with the sorbent.

11. The method as in claim 10, wherein the contaminant is nitrate or nitrogen.

12. The method as in claim 10, wherein the contaminant is phosphate or phosphorus.

13. The method as in claim 10, wherein the contaminant is PFAS.

14. The method as in claim 9, wherein the metal ion or mixture of metal ions comprises at least one metal ion selected from the group consisting: iron, zinc, magnesium, zirconium, and aluminum.

15. The method as in claim 9, wherein the polluted water is 40 ml of polluted water, and wherein step c) comprises reducing 10 ppm inorganic nitrogen by at least 45%, reducing 50 ppm total nitrogen by at least 20%, and reducing 30 ppm phosphorus by at least 35%.

16. The method as in claim 15, wherein step c) comprises reducing 10 ppm inorganic nitrogen by at least 80%, reducing 50 ppm total nitrogen by at least 20%, and reducing 30 ppm phosphorus by at least 40%.

17. A sorbent for nutrient removal from water, comprising:
a) a carbon content of at least 80 weight percent;
b) a metal ion content of at least 1 weight percent;
c) a chlorine content of at least 0.5 weight percent; and,
d) a BET surface area of at least 100 m²/g.

18. The sorbent as in claim 17, wherein the sorbent comprises a BET surface area of at least 800 m²/g.

19. The sorbent as in claim 17, wherein the sorbent selectively removes at least nitrates or phosphates from water.

20. The sorbent as in claim 17, wherein the metal ion derives from one of the following: ferric chloride, ferrous chloride, ferrous sulfate, ferric sulfate, iron oxide, iron hydroxide, aluminum chloride, aluminum oxide, aluminum hydroxide, zirconium chloride, zirconium oxide, zirconium hydroxide, zinc oxide, zinc hydroxide, magnesium oxide, magnesium hydroxide.
